(19) United States
(12) Patent Application Publication
(10) Pub. No.: US 2026/0086423 A1
(43) Pub. Date: Mar. 26, 2026

(54) Camera Lens Actuators With Shape Memory Alloy Wires for Autofocus and Ball Bearing Suspension

(71) Applicant: Apple Inc., Cupertino, CA (US)

(72) Inventors: Andrew S. Jozefov, San Francisco, CA (US); Alfred N. Mireault, San Francisco, CA (US); Scott W. Miller, Los Gatos, CA (US)

(73) Assignee: Apple Inc., Cupertino, CA (US)

(21) Appl. No.: 19/315,223

(22) Filed: Aug. 29, 2025

Related U.S. Application Data
(60) Provisional application No. 63/698,505, filed on Sep. 24, 2024.

(51) Int. Cl. G03B 5/00; G03B 13/36

(52) U.S. Cl. CPC G03B 5/00; G03B 13/36; G03B 2205/0007; G03B 2205/0069

(57) ABSTRACT

An actuator assembly for a camera includes a plurality of carriers each configured to allow movement of an optical assembly along respective axes of the optical axis, a first axis orthogonal to the optical axis, and a second axis orthogonal to the first axis and the optical axis. Ball bearings for the carriers allow for movement along the axes. Actuators move the optical assembly, via the respective carriers, along the axes in response to receiving electrical current. The actuators include one or more shape memory alloy (SMA) wires for moving the optical assembly, via at least one carrier of the plurality of carriers, along the optical axis for autofocus (AF).

### BACKGROUND

This application claims benefit of priority to U.S. Provisional Application Serial No. 63/698,505, entitled “Camera Lens Actuators with Shape Memory Alloy Wires for Autofocus and Ball Bearing Suspension,” filed Sep. 24, 2024, and which is hereby incorporated herein by reference in its entirety.

### Technical Field

This disclosure relates generally to a lens-shift ball bearing camera actuator having voice coil motor (VCM) optical image stabilization (OIS) coils and shape memory alloy (SMA) wire actuators for autofocus (AF).

### Description of the Related Art

The advent of small, mobile multipurpose devices such as smartphones and tablet or pad devices has resulted in a need for high-resolution, small form factor cameras for integration in the devices. Some cameras may incorporate an autofocus (AF) mechanism whereby the object focal distance can be adjusted to focus an object plane in front of the camera at an image plane to be captured by the image sensor. Further, some cameras may incorporate optical image stabilization (OIS) mechanisms that may sense and react to external excitation/disturbance by adjusting location of the optical lens on the X and/or Y axis in an attempt to compensate for unwanted motion of the lens.

### BRIEF DESCRIPTION OF THE DRAWINGS

FIG. 1 illustrates components of an example camera having an actuator module or assembly that may, for example, be used to provide autofocus (AF) and optical image stabilization (OIS) through lens movement in small form factor cameras, according to at least some embodiments. FIG. 1 shows an overhead view of the exterior of the camera.

FIG. 2 illustrates components of an example camera having an actuator module or assembly that may, for example, be used to provide AF and OIS through lens movement in small form factor cameras, according to at least some embodiments. FIG. 2 shows a cross-sectional view of the camera.

FIG. 3 illustrates components of an example camera having actuator module or assembly that may, for example, be used to provide AF and OIS through lens movement in small form factor cameras, according to at least some embodiments. FIG. 3 shows a perspective view of the camera.

FIG. 4 illustrates components of an example camera having an actuator module or assembly that may, for example, be used to provide AF and OIS through lens movement in small form factor cameras, according to at least some embodiments. FIG. 4 shows an exploded view of the camera.

FIG. 5 illustrates components of an example actuator module or assembly that may, for example, be used to provide AF and OIS through lens movement in small form factor cameras, according to at least some embodiments. FIG. 5 shows a perspective view of an actuator assembly base and autofocus (AF) carrier of an actuator module or assembly.

FIG. 6 illustrates components of an example AF actuator assembly of an actuator module or assembly that may, for example, be used to provide AF and OIS through lens movement in small form factor cameras, according to at least some embodiments. FIG. 6 shows a perspective view of an AF actuator assembly of an actuator module or assembly.

FIG. 7 illustrates components of an optical image stabilization (OIS) actuator assembly and an AF actuator assembly of an actuator module or assembly that may, for example, be used to provide AF and OIS through lens movement in small form factor cameras, according to at least some embodiments. FIG. 7 shows a perspective view of an OIS actuator assembly and an AF actuator assembly of an actuator module or assembly.

FIG. 8 illustrates components of an example actuator module or assembly that may, for example, be used to provide AF and OIS through lens movement in small form factor cameras, according to at least some embodiments. FIG. 8 shows a perspective view of the actuator module or assembly.

FIG. 9 illustrates components of an example actuator module or assembly that may, for example, be used to provide AF and OIS through lens movement in small form factor cameras, according to at least some embodiments. FIG. 9 shows a perspective view of the actuator module or assembly.

FIG. 10 illustrates components of an example actuator module or assembly that may, for example, be used to provide AF and OIS through lens movement in small form factor cameras, according to at least some embodiments. FIG. 10 shows a perspective view of the actuator module or assembly.

FIG. 11 illustrates components of an example actuator module or assembly that may, for example, be used to provide AF and OIS through lens movement in small form factor cameras, according to at least some embodiments. FIG. 11 shows a perspective view of the actuator module or assembly.

FIG. 12 illustrates components of an example actuator module or assembly that may, for example, be used to provide AF and OIS through lens movement in small form factor cameras, according to at least some embodiments. FIG. 12 shows a perspective view of the actuator module or assembly.

FIG. 13 illustrates a schematic representation of an example device that may include a camera, in accordance with some embodiments.

FIG. 14 illustrates a schematic block diagram of an example computing device, referred to as computer system, that may include or host embodiments of a camera, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units ….” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine a based on B.” While in this case, b is a factor that affects the determination of A, such a phrase does not foreclose the determination of a from also being based on C. In other instances, a may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term "and/or" as used herein refers to and encompasses any and all possible combinations of one or more of the associated listed items. It will be further understood that the terms "includes," "including," "comprises," and/or "comprising," when used in this specification, specify the presence of stated features, integers, steps, operations, elements, and/or components, but do not preclude the presence or addition of one or more other features, integers, steps, operations, elements, components, and/or groups thereof.

As used herein, the term "if" may be construed to mean "when" or "upon" or "in response to determining" or "in response to detecting," depending on the context. Similarly, the phrase "if it is determined" or "if [a stated condition or event] is detected" may be construed to mean "upon determining" or "in response to determining" or "upon detecting [the stated condition or event]" or "in response to detecting [the stated condition or event]," depending on the context.

### DETAILED DESCRIPTION

Various embodiments described herein relate to an actuator module or assembly that may be used in a camera with a moveable optical assembly. In some examples, the camera may include camera equipment outfitted with controls, magnets, voice coil motors, and shape memory allow (SMA) wires to improve the effectiveness of a miniature actuation mechanism for a compact camera module. More specifically, in some embodiments, compact camera modules include actuators to deliver functions such as autofocus (AF) and optical image stabilization (OIS). One approach to delivering a very compact actuator assembly is to provide AF and OIS actuators for movement and/or shift of the optical assembly.

Compact cameras (e.g., camera modules) may be used across a variety of mobile devices from cell phones to AR/VR devices. Many cameras may implement AF actuators in order to improve focus performance and support lower F-numbers and OIS actuators to compensate for shaking and movement of the camera. In some designs, a camera actuator may include voice coil motors (VCM) actuators (e.g., each having at least one magnet and at least one coil) and suspension assemblies (e.g., including wires and/or springs) for moving the lens package in the x, y, and/or z directions for OIS and AF. However, with these components, the forces generated by the VCM actuators and the damping provided by the suspension assemblies may limit the size and weight of lenses and other components thereby limiting the performance of the camera.

Conversely, actuator modules or assemblies that include ball bearings and SMA wire actuators may allow for heavy and more robust lenses and other components to enhance the performance of the camera. As described herein, a camera with an actuator module or assembly may include a plurality of carriers that utilize ball bearings for AF and OIS movement of the optical assembly. The actuators may also include at least one SMA wire actuator for movement of the optical assembly. For instance, the actuator assembly may include an AF carrier having one or more cap stands with at least one SMA wire looped over each cap stand. The SMA wires may be attached to a stationary component of the camera (e.g., a base or a flex circuit). Through electrical connections at the stationary component of the camera, the SMA wires may receive an electrical current causing one or more of the SMA wires to contract and/or expand and move the AF carrier, the first OIS carrier, the second OIS carrier, and the optical assembly along the optical axis, via ball bearings, for AF. In other words, with the AF carrier positioned below the first OIS carrier, the second OIS carrier, and the optical assembly, both the first OIS carrier and the second OIS carrier may move along the optical axis when the AF carrier moves along the optical axis to produce AF movement of the optical assembly. A first magnet attached to the second OIS carrier may align with a coil on the base or on a flex circuit such that when that coil receives an electrical current, the second OIS carrier due to the magnet may experience Lorenze forces that move the first OIS carrier, the second OIS carrier, and the optical assembly along a first axis orthogonal to the optical axis, via ball bearings, for OIS stabilization (e.g., in the x-direction or the y-direction). In other words, with the first OIS carrier positioned below the second OIS carrier and the optical assembly, both the first OIS carrier and the second OIS carrier may move along the first axis when the first OIS carrier moves along the first axis to produce OIS movement of the optical assembly (e.g., in the x-direction, or the y-direction). In addition, a second magnet attached to the second OIS carrier may align with another coil on the base or on a flex circuit such that when that coil receives an electrical current, the second OIS carrier due to the magnet may experience Lorenze forces that move the second OIS carrier and the optical assembly along a second axis orthogonal to the first axis and the optical axis, via ball bearings, for OIS stabilization (e.g., in the y-direction or the x-direction). In other words, with the second OIS carrier and the optical assembly positioned above the first OIS carrier, only the second OIS carrier may move along the second axis to produce OIS movement of the optical assembly (e.g., in the y-direction, or the x-direction).

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

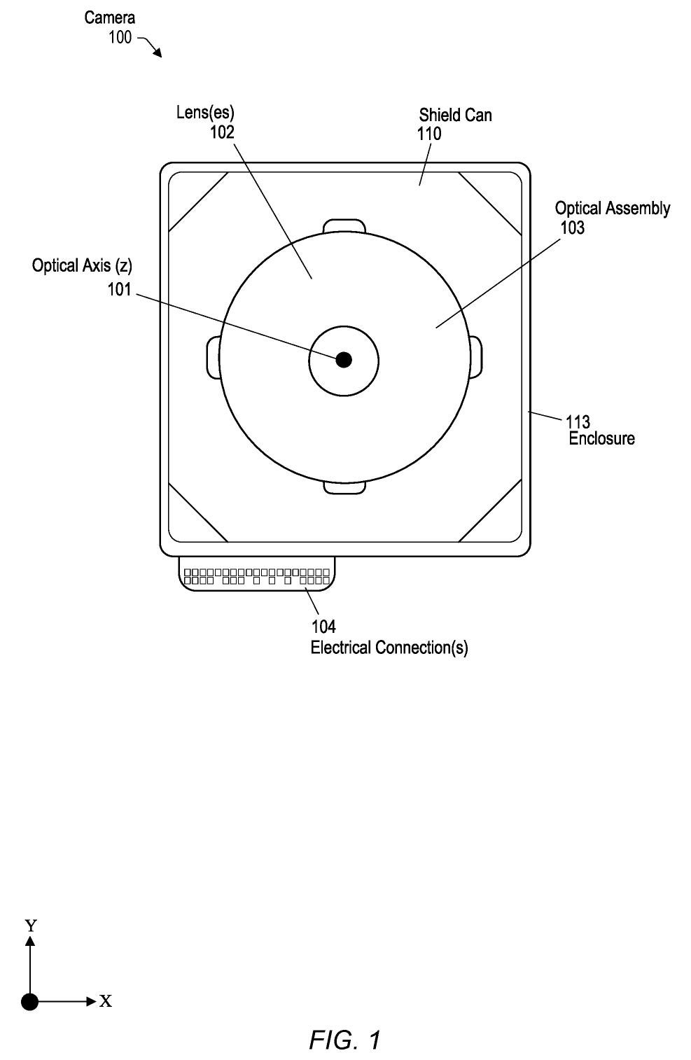

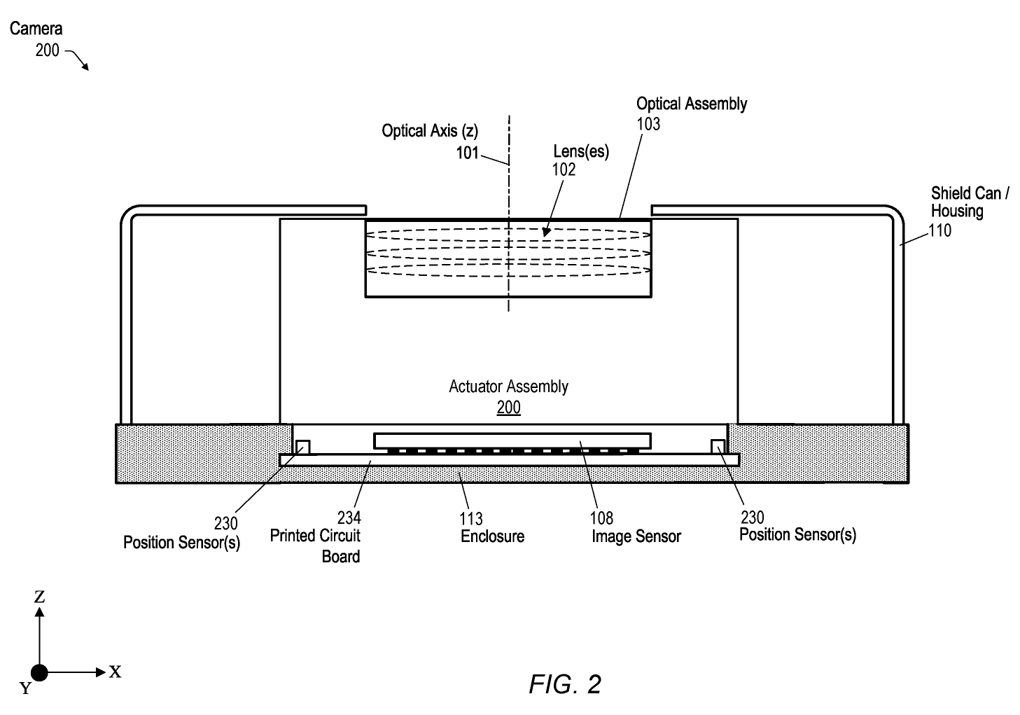

FIG. 1 illustrates components of an example camera 100 having an actuator module or assembly that may, for example, be used to provide autofocus (AF) and optical image stabilization (OIS) through lens movement in small form factor cameras, according to at least some embodiments. FIG. 1 shows an overhead view of the exterior of the camera 100.The camera 100 may include one or more same or similar features as the features described with respect to or illustrated in FIGS. 2, 3, 4, 5, 6, 7, 8, 9, 10, 11, 12, 13, and 14. The example X-Y-Z coordinate system shown in FIG. 1 may be used to discuss aspects of components and/or systems, and may apply to embodiments described throughout this disclosure.

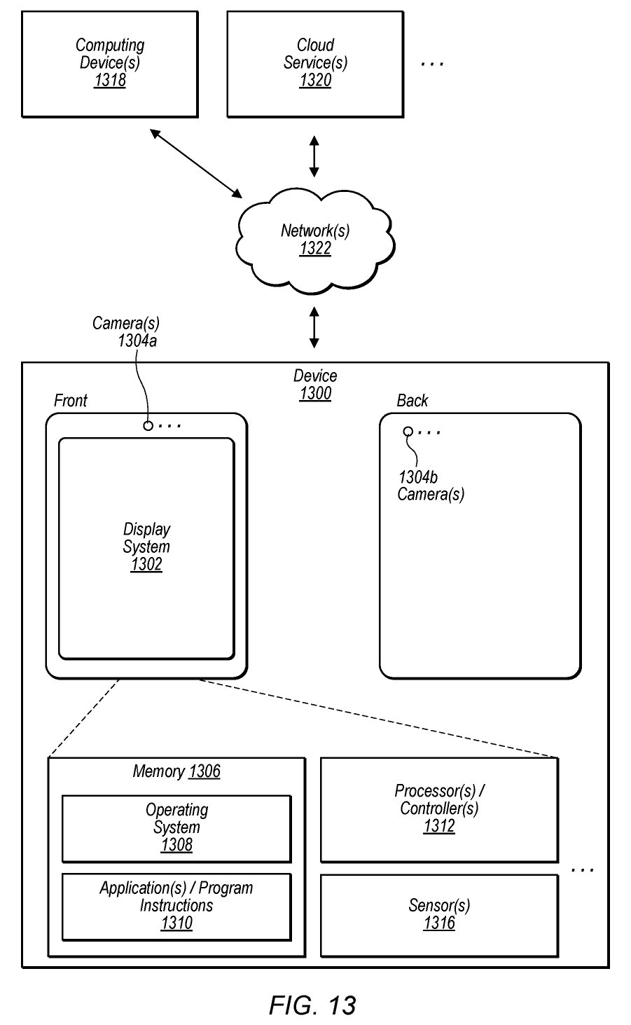

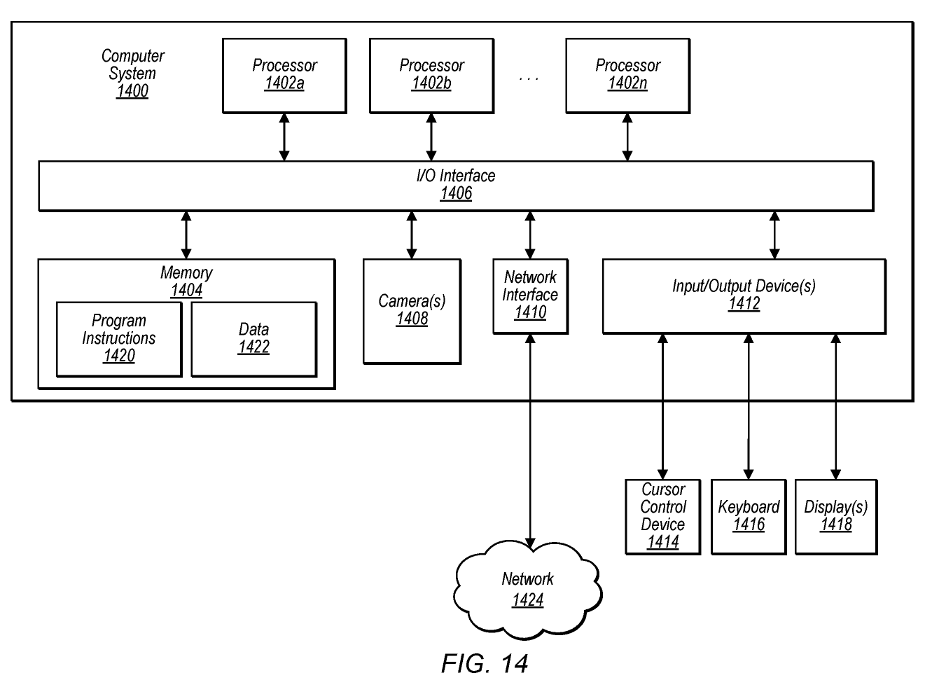

In various embodiments, the camera 100 may include an optical assembly 103 having one or more lenses 102 defining an optical axis (z) 101, a shield can 110, an enclosure 113, and electrical connection(s) 104. The shield can 110 may form an outer wall of a top portion (and in some cases side portions) of the camera 100 and form one or more camera shoulders. The enclosure 113 may form an outer wall of a bottom portion of the camera 100. The electrical connection(s) 104 may extend from the enclosure 113 (and shield can 110) and may electrically connect the camera 100 to an external device. For example, the camera 100 may be the same or similar camera as the camera 1304b illustrated in FIG. 13 or the camera 1408 illustrated in FIG. 14. As such, the electrical connection(s) 104 may extend from the enclosure 113 and may electrically connected the camera 100 to the device 1300 illustrated in FIG. 13 or the computer system 1400 illustrated in FIG. 14, respectively. In some aspects, the shield can 110 may be mechanically coupled to a base via the enclosure 113 attached to both the shield can 110 and the base. As describe herein, the camera 100 may include AF and OIS of the optical assembly.

FIG. 2 illustrates components of an example camera 100 having an actuator module or assembly that may, for example, be used to provide AF and OIS through lens movement in small form factor cameras, according to at least some embodiments. FIG. 2 shows a cross-sectional view of the camera 100. The camera 100 may include one or more same or similar features as the features described with respect to or illustrated in FIGS. 1, 3, 4, 5, 6, 7, 8, 9, 10, 11, 12, 13, and 14. The example X-Y-Z coordinate system shown in FIG. 2 may be used to discuss aspects of components and/or systems, and may apply to embodiments described throughout this disclosure.

As shown in FIG. 2, the camera 100 may include an optical assembly 103 including one or more lenses 102 centered on an optical axis (z) 101, a shield can 110, a printed circuit board (or a substrate) 234, an image sensor 108, a plurality of position sensors 230, the enclosure 113, and the actuator assembly 200. The shield can 110 coupled to the enclosure 113 may contain the actuator assembly 200, the printed circuit board 234, the image sensor 108, and the plurality of position sensors 230. The actuator assembly 200 may be attached to the optical assembly 103 for moving the optical assembly 103 for moving the optical assembly for AF and OIS, as described herein.

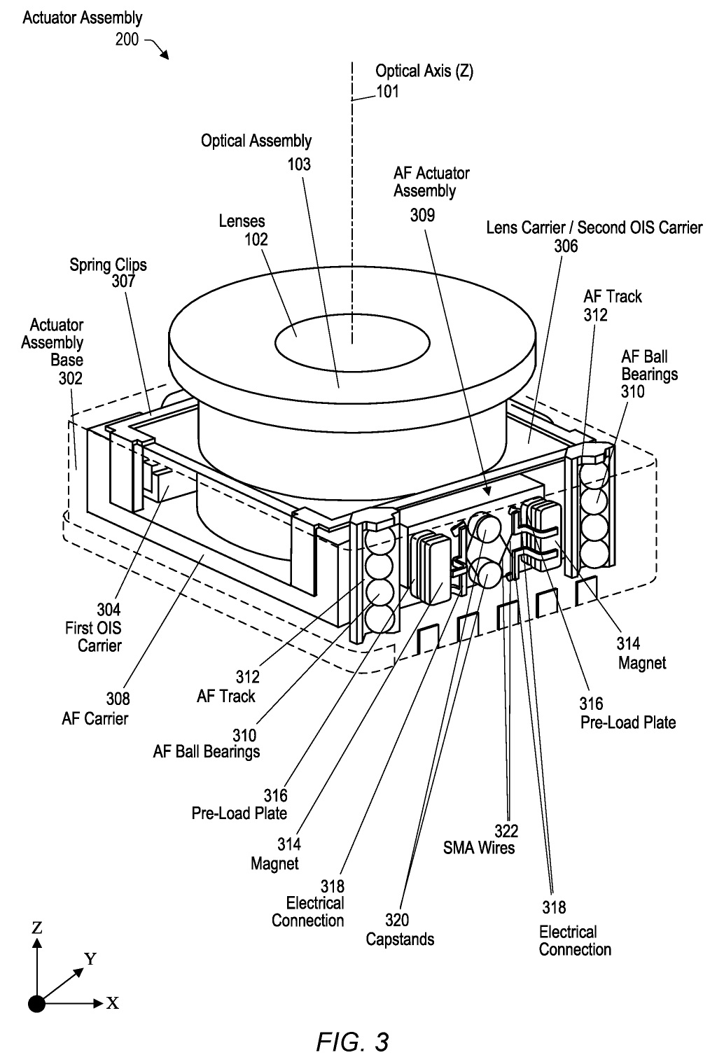

FIG. 3 illustrates components of an example actuator module or assembly 200 that may, for example, be used to provide AF and OIS through lens movement in small form factor cameras, according to at least some embodiments. FIG. 3 shows a perspective view of the actuator module or assembly 200. The actuator assembly 200 may include one or more same or similar features as the features described with respect to or illustrated in FIGS. 1, 2, 4, 5, 6, 7, 8, 9, 10, 11, 12, 13, and 14. The example X-Y-Z coordinate system shown in FIG. 3 may be used to discuss aspects of components and/or systems, and may apply to embodiments described throughout this disclosure.

As shown in FIG. 3, the actuator assembly 200 includes an actuator assembly base 302, and a plurality of carriers including a first OIS carrier 304, lens carrier / second OIS carrier 306, and an AF carrier 308. The first OIS carrier 304, the lens carrier / second OIS carrier 306, and the AF carrier 308 may form a vertical carrier stack on and/or over the actuator assembly base 302. The vertical carrier stack may be arranged such that the AF carrier 308 may be stacked under and/or below the first OIS carrier 304, the lens carrier / second OIS carrier 306, and the optical assembly 103. The first OIS carrier 304 may be stacked or positioned below and/or under the lens carrier / second OIS carrier 306, and the optical assembly 103. The lens carrier / second OIS carrier 306 may be attached to the optical assembly 103.

Also, as shown in FIG. 3, the AF carrier 308 may be positioned on the actuator assembly base 302. As such, when an image sensor (e.g., the image sensor 108 of FIG. 2) is position below the actuator assembly base 302 on an opposite side of the actuator assembly base 302 from the optical assembly 103, the vertical stack of carriers may be arranged from the image sensor to the optical assembly 103 in an order as follows: the actuator assembly base 302, the AF carrier 308, first OIS carrier 304, and the lens carrier / second OIS carrier 306. Unlike some actuator assemblies that utilize a plurality of VCM actuators for both OIS movement and AF movement, the actuator assembly 200 may utilize SMA wires 332 for AF movement of the optical assembly 103 via the AF carrier 308 while utilizing VCM actuators for OIS movement of the optical assembly 130. Using SMA wires for AF movement of the optical assembly 103 may provide higher actuation forces to overcome and attenuate high frequency and high acceleration disturbances.

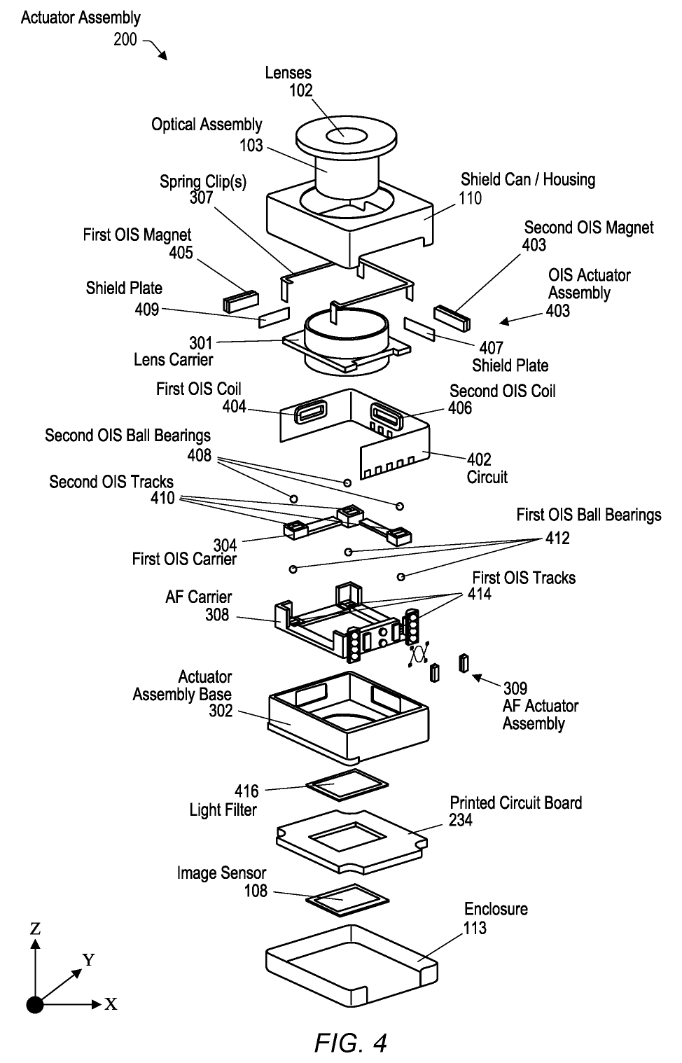

The actuator assembly base 302 may be static relative to AF carrier 308, the first OIS carrier 304, and the lens carrier / second OIS carrier 306. The AF carrier 308, the first OIS carrier 304, and the lens carrier / second OIS carrier 306 (and thus the optical assembly 103) may move along the optical axis 101 relative to the actuator assembly base 302 when the AF actuator assembly 309 activates for AF. For example, the AF actuator assembly 309 may include AF ball bearings residing within an AF track 312 vertically formed by both the AF carrier 308 and the actuator assembly base 302 allowing for AF movement along the optical axis 101 of the AF carrier 308, the first OIS carrier 304, the lens carrier / second OIS carrier 306, and the optical assembly 103 relative to the actuator base assembly 302. One or more spring clip(s) 307 positioned over the lens carrier / second OIS carrier 306 and attached the AF carrier 308 may prevent the lens carrier / second OIS carrier 306 from separating vertically (e.g., along the optical axis 101) from the first OIS carrier 304 and the AF carrier 308. Pre-load plates 316 attached to the AF carrier 308 and magnets 314 attached to the actuator assembly base 302 and aligned with the pre-load plates 316 draw the AF carrier 308 towards to the actuator assembly base 302 for retaining the ball bearings 310 within the AF track formed by both the AF carrier 308 and the actuator assembly base 302. Electrical connections 318 fixedly attached to the actuator assembly base 302 and/or a circuit (e.g., circuit 402 of FIG. 4) that remains static with the actuator assembly base 302 and relative to movement of the AF carrier 308, retain ends of a pair of SMA wires 322 in a static position. The electrical connections 318 may carry an electrical current to and from the SMA wires 322 and mechanically attached (e.g., fixedly attach) or secure the SMA wires 322 to the static actuator assembly base 302 and/or the circuit. The SMA wires 322 are looped around respective cap stands 320 extending from the AF carrier 308 in a direction orthogonal to the optical axis 101 and positioned in a vertical configuration with one cap stand 320 above the other cap stand 320 in a direction along the optical axis 101. When an SMA wire 322 looped around the higher cap stand 320 receives an electrical current via the electrical connections 318, that SMA wire 322 contracts generating a force that pulls the AF carrier 308, the first OIS carrier 304, the lens carrier / second OIS carrier 306 and the optical assembly 103 along the optical axis 101 and towards the image sensor 108. When an SMA wire 322 looped around the lower cap stand 320 receives an electrical current via the electrical connections 318, that SMA wire 322 contracts generating a force that pulls the AF carrier 308, the first OIS carrier 304, the lens carrier / second OIS carrier 306 and the optical assembly 103 along the optical axis 101 and away from the image sensor 108. Thus, providing electrical current to the SMA wires 322 causes the SMA wires to contract and move the optical assembly 103 along the optical axis 101 for AF movement.

The AF carrier 308 may also include ball bearings that engage and move within tracks formed on an object side of the AF carrier 308 and an image side of the first OIS carrier 304. As such, the ball bearings of the AF carrier 308 and the tracks formed on the object side of the AF carrier 308 and the image side of the first OIS carrier 304 may allow the first OIS carrier 304, the lens carrier / second OIS carrier 306, and optical assembly 103 to move along first axis (e.g., orthogonal to the optical axis 101) for OIS movement of the optical assembly 103. A VCM actuator including a coil (e.g., a first OIS coil 404 illustrated in FIG. 4) and a magnet (e.g., a first OIS magnet 405 illustrated in FIG. 4) may move the first OIS carrier 304, the lens carrier / second OIS carrier 306, and the optical assembly 103 along the first axis for OIS movement. For example, a coil (e.g., a first OIS coil 404 illustrated in FIG. 4) attached to the actuator assembly base 302 and/or the circuit (e.g., circuit 402 illustrated in FIG. 4) may electromagnetically interact with a magnet (e.g., a first OIS magnet 405 illustrated in FIG. 4) attached to the first OIS carrier 304 may cause movement of the first OIS carrier 304, the lens carrier / second OIS carrier 306, and the optical assembly 103 along the first axis. Further, the first OIS carrier 304 may include ball bearings that engage and move within tracks formed on an object side of the first OIS carrier 304 and on an image side of the lens carrier / second OIS carrier 306. As such, the ball bearing of the first OIS carrier 304 and the tracks formed on the object side of the first OIS carrier 304 and on the image side of the lens carrier / second OIS carrier 306 may allow the lens carrier / second OIS carrier 306 and the optical assembly 103 to move independently of the first OIS carrier 304 and along the second axis (e.g., orthogonal to the optical axis 101 and the first axis) for OIS movement of the optical assembly 103. A VCM actuator including a coil (e.g., a second OIS coil 406 illustrated in FIG. 4) and a magnet (e.g., a second OIS magnet 403 illustrated in FIG. 4) may move the lens carrier / second OIS carrier 306 and the optical assembly 103 along the second axis for OIS movement. For example, a coil (e.g., a second OIS coil 406 illustrated in FIG. 4) attached to the actuator assembly base 302 and/or the circuit (e.g., circuit 402 illustrated in FIG. 4) may electromagnetically interact with a magnet (e.g., a second OIS magnet 403 illustrated in FIG. 4) attached to the lens carrier / second OIS carrier 306 may cause movement of the lens carrier / second OIS carrier 306 and the optical assembly 103 along the second axis.

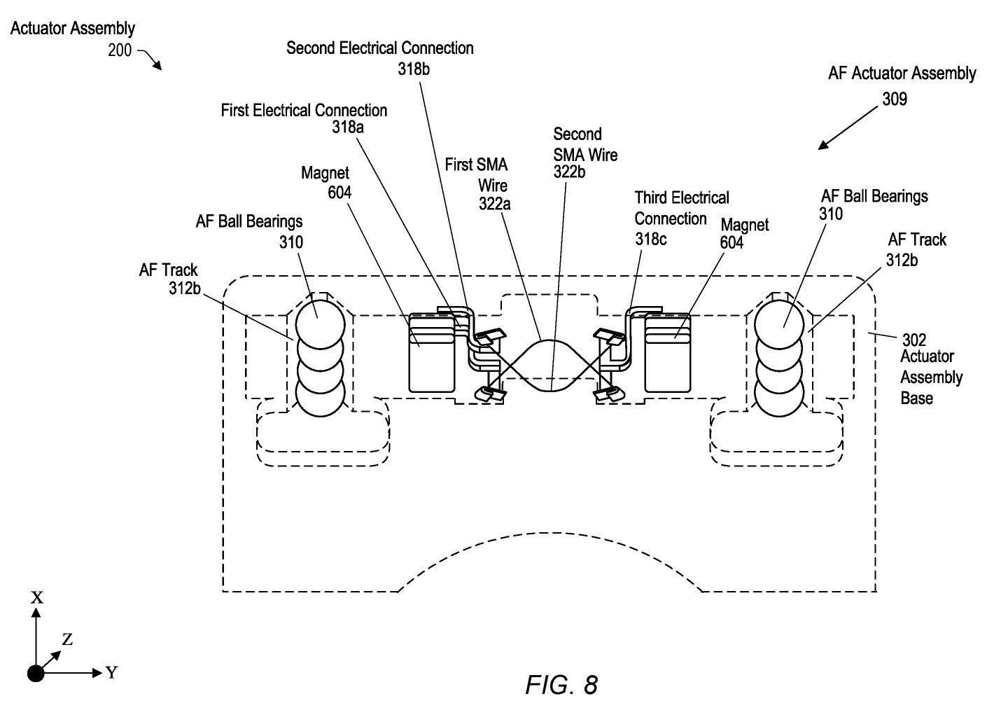

FIG. 4 illustrates components of an example camera 100 having an actuator module or assembly 200 that may, for example, be used to provide AF and OIS through lens movement in small form factor cameras, according to at least some embodiments. FIG. 4 shows an exploded view of the camera 100. The actuator assembly 200 may include one or more same or similar features as the features described with respect to or illustrated in FIGS. 1, 2, 3, 4, 5, 6, 7, 9, 10, 11, and 12. The example X-Y-Z coordinate system shown in FIG. 8 may be used to discuss aspects of components and/or systems, and may apply to embodiments described throughout this disclosure.

As shown in FIG. 4, the camera 100 may include an enclosure 113 that receives a printed circuit board (PCB) 234 having the image sensor 108 and a light filter 416 (e.g., infrared cutoff filter, UV filter) attached thereto. The enclosure 113 together with the shield can / housing 110 may enclose the actuator assembly 200. The actuator assembly 200 may include the actuator assembly base 302, the AF carrier 308, the first OIS carrier 304, and the lens carrier / second OIS carrier 306.

The AF carrier 308 may be positioned on the actuator assembly base 302. As such, when the image sensor 108 is positioned below the actuator assembly base 302 on an opposite side of the actuator assembly base 302 from the optical assembly 103, the vertical stack of carriers may be arranged from the image sensor 108 to the optical assembly 103 in an order as follows: the actuator assembly base 302, the AF carrier 308, first OIS carrier 304, and the lens carrier / second OIS carrier 306. Unlike some actuator assemblies that utilize a plurality of VCM actuators for both OIS movement and AF movement, the actuator assembly 200 may including an AF actuator assembly 309 that utilizes SMA wires 332 for AF movement of the optical assembly 103 via the AF carrier 308 while the actuator assembly 200 utilizes VCM actuators for OIS movement of the optical assembly 130. Using SMA wires for AF movement of the optical assembly 103 may provide higher actuation forces to overcome and attenuate high frequency and high acceleration disturbances.

The actuator assembly base 302 may be static relative to AF carrier 308, the first OIS carrier 304, and the lens carrier / second OIS carrier 306. The AF carrier 308, the first OIS carrier 304, and the lens carrier / second OIS carrier 306 (and thus the optical assembly 103) may move along the optical axis 101 relative to the actuator assembly base 302 when the AF actuator assembly 309 activates for AF. For example, the AF actuator assembly 309 may include AF ball bearings residing within an AF track 312 vertically formed by both the AF carrier 308 and the actuator assembly base 302 allowing for AF movement along the optical axis 101 of the AF carrier 308, the first OIS carrier 304, the lens carrier / second OIS carrier 306, and the optical assembly 103 relative to the actuator base assembly 302. One or more spring clip(s) 307 positioned over the lens carrier / second OIS carrier 306 and attached the AF carrier 308 may prevent the lens carrier / second OIS carrier 306 from separating from the first OIS carrier 304 and the AF carrier 308. Pre-load plates attached to the AF carrier 308 and magnets attached to the actuator assembly base 302 and aligned with the pre-load plates 316 draw the AF carrier 308 towards to the actuator assembly base 302 for retaining the ball bearings within the AF track formed by both the AF carrier 308 and the actuator assembly base 302. Electrical connections fixedly attached to the actuator assembly base 302 and/or the circuit 402 at least partially surrounding the plurality of carriers (e.g., and attached to the actuator assembly base 302 and/or the PCB 234) and that remains static with the actuator assembly base 302 and relative to movement of the AF carrier 308, retain ends of a pair of SMA wires 322 in a static position. The electrical connections may carry an electrical current to and from the SMA wires 322 and mechanically attached (e.g., fixedly attach) or secure the SMA wires 322 to the static actuator assembly base 302 and/or the circuit 402. The SMA wires 322 are looped around respective cap stands extending from the AF carrier 308 in a direction orthogonal to the optical axis 101 and positioned in a vertical configuration with one cap stand above the other cap stand in a direction along the optical axis 101. When an SMA wire 322 looped around the higher cap stand receives an electrical current via the electrical connections, that SMA wire 322 contracts generating a force that pulls the AF carrier 308, the first OIS carrier 304, the lens carrier / second OIS carrier 306 and the optical assembly 103 along the optical axis 101 and towards the image sensor 108. When an SMA wire 322 looped around the lower cap stand receives an electrical current via the electrical connections, that SMA wire 322 contracts generating a force that pulls the AF carrier 308, the first OIS carrier 304, the lens carrier / second OIS carrier 306 and the optical assembly 103 along the optical axis 101 and away from the image sensor 108. Thus, providing electrical current to the SMA wires 322 causes the SMA wires to contract and move the optical assembly 103 along the optical axis 101 for AF movement.

The AF carrier 308 may also include first OIS ball bearings 412 that engage and move within first OIS tracks 414 formed on an object side of the AF carrier 308 and an image side of the first OIS carrier 304. As such, the first OIS ball bearings 412 and the first OIS tracks 414 formed on the object side of the AF carrier 308 and the image side of the first OIS carrier 304 may allow the first OIS carrier 304, the lens carrier / second OIS carrier 306, and optical assembly 103 to move along first axis (e.g., orthogonal to the optical axis 101) for OIS movement of the optical assembly 103. A VCM actuator including a first OIS coil 404 attached to the circuit 402 and a first OIS magnet 405 attached to the first OIS carrier 304 may move the first OIS carrier 304, the lens carrier / second OIS carrier 306, and the optical assembly 103 along the first axis for OIS movement of the optical assembly 103. For example, the first OIS coil 404 attached to the actuator assembly base 302 and/or the circuit 402 may be aligned with and may electromagnetically interact with the first OIS magnet 405 attached to the first OIS carrier 304 to cause movement of the first OIS carrier 304, the lens carrier / second OIS carrier 306, and the optical assembly 103 along the first axis when the first OIS coil 404 receives an electrical current. Further, the first OIS carrier 304 may include second OIS ball bearings 408 that engage and move within second OIS tracks 410 formed on an object side of the first OIS carrier 304 and on an image side of the lens carrier / second OIS carrier 306. As such, the second OIS ball bearings 408 of the first OIS carrier 304 and the second OIS tracks 410 formed on the object side of the first OIS carrier 304 and on the image side of the lens carrier / second OIS carrier 306 may allow the lens carrier / second OIS carrier 306 and the optical assembly 103 to move independently of the first OIS carrier 304 and along the second axis (e.g., orthogonal to the optical axis 101 and the first axis) for OIS movement of the optical assembly 103. A VCM actuator including a second OIS coil 406 and a second OIS magnet 403 attached to the lens carrier / second OIS carrier 306 may move the lens carrier / second OIS carrier 306 and the optical assembly 103 along the second axis for OIS movement. For example, the second OIS coil 406 attached to the actuator assembly base 302 and/or the circuit 402 may be aligned with and may electromagnetically interact with the second OIS magnet 403 attached to the lens carrier / second OIS carrier 306 to cause movement of the lens carrier / second OIS carrier 306 and the optical assembly 103 along the second axis. A shield plate 407 may be positioned against the second OIS magnet 403 to direct the magnetic field from the second OIS magnet 403 to second OIS coil 406. Similarly, a shield plate 409 may be positioned against the first OIS magnet 405 to direct the magnetic field from the first OIS magnet 405 to first OIS coil 404.

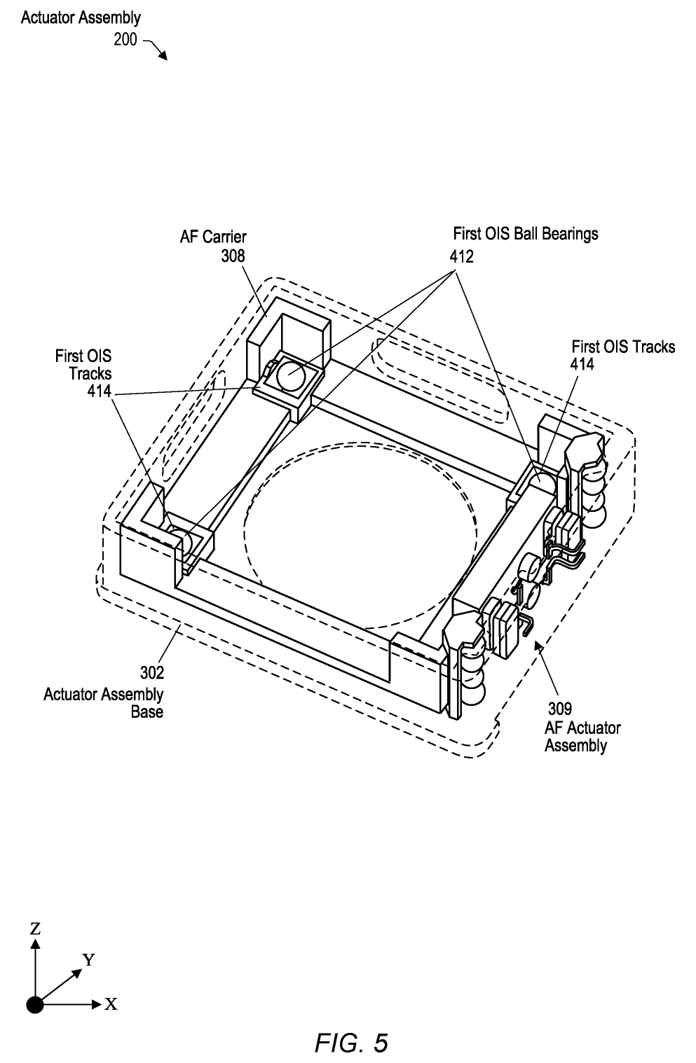

FIG. 5 illustrates components of an example actuator module or assembly 200 that may, for example, be used to provide AF and OIS through lens movement in small form factor cameras, according to at least some embodiments. FIG. 5 shows a perspective view of an actuator assembly base 302 and autofocus (AF) carrier 308 of an actuator module or assembly 200. The actuator assembly base 302 and the actuator assembly 200 may include one or more same or similar features as the features described with respect to or illustrated in FIGS. 1, 2, 3, 4, 6, 7, 8, 9, 10, 11, 12, 13, and 14. The example X-Y-Z coordinate system shown in FIG. 5 may be used to discuss aspects of components and/or systems, and may apply to embodiments described throughout this disclosure.

As shown in FIG. 5, the AF carrier 308 may be positioned on the actuator assembly base 302. Unlike some actuator assemblies that utilize a plurality of VCM actuators for both OIS movement and AF movement, the actuator assembly 200 may including an AF actuator assembly 309 that utilizes SMA wires for AF movement of the optical assembly via the AF carrier 308 while the actuator assembly 200 utilizes VCM actuators for OIS movement of the optical assembly 130. Using SMA wires for AF movement of the optical assembly 103 may provide higher actuation forces to overcome and attenuate high frequency and high acceleration disturbances.

The actuator assembly base 302 may be static relative to AF carrier 308 (and the first OIS carrier 304 and the lens carrier / second OIS carrier 306). The AF carrier 308 (and the first OIS carrier 304, and the lens carrier / second OIS carrier 306 (and thus the optical assembly 103)) may move along the optical axis 101 relative to the actuator assembly base 302 when the AF actuator assembly 309 activates for AF. For example, the AF actuator assembly 309 may include AF ball bearings residing within an AF track vertically formed by both the AF carrier 308 and the actuator assembly base allowing for AF movement along the optical axis 101 of the AF carrier 308 (and the first OIS carrier 304, the lens carrier / second OIS carrier 306, and the optical assembly 103) relative to the actuator base assembly 302. Pre-load plates attached to the AF carrier 308 and magnets attached to the actuator assembly base 302 and aligned with the pre-load plates 316 draw the AF carrier 308 towards to the actuator assembly base 302 for retaining the ball bearings within the AF track formed by both the AF carrier 308 and the actuator assembly base 302. Electrical connections fixedly attached to the actuator assembly base 302 and/or a circuit at least partially surrounding the plurality of carriers and that remains static with the actuator assembly base 302 and relative to movement of the AF carrier 308, retain ends of a pair of SMA wires in a static position. The electrical connections may carry an electrical current to and from the SMA wires and mechanically attached (e.g., fixedly attach) or secure the SMA wires to the static actuator assembly base 302 and/or the circuit. The SMA wires are looped around respective cap stands extending from the AF carrier 308 in a direction orthogonal to the optical axis and positioned in a vertical configuration with one cap stand above the other cap stand in a direction along the optical axis. When an SMA wire looped around the higher cap stand receives an electrical current via the electrical connections, that SMA wire contracts generating a force that pulls the AF carrier 308 (and the first OIS carrier 304, the lens carrier / second OIS carrier 306 and the optical assembly 103) along the optical axis 101 and towards the image sensor 108 and the actuator assembly base 302. When an SMA wire looped around the lower cap stand receives an electrical current via the electrical connections, that SMA wire contracts generating a force that pulls the AF carrier 308, the first OIS carrier 304, the lens carrier / second OIS carrier 306 and the optical assembly 103 along the optical axis 101 and away from the image sensor 108. Thus, providing electrical current to the SMA wires 322 causes the SMA wires to contract and move the optical assembly 103 along the optical axis 101 for AF movement.

The AF carrier 308 may also include first OIS ball bearings 412 that engage and move within first OIS tracks 414 formed on an object side of the AF carrier 308 and an image side of the first OIS carrier 304. As such, the first OIS ball bearings 412 and the first OIS tracks 414 formed on the object side of the AF carrier 308 and the image side of the first OIS carrier 304 may allow the first OIS carrier 304, the lens carrier / second OIS carrier 306, and optical assembly 103 to move along first axis (e.g., orthogonal to the optical axis 101) for OIS movement of the optical assembly 103. A VCM actuator including a first OIS coil 404 attached to the circuit 402 and a first OIS magnet 405 attached to the first OIS carrier 304 may move the first OIS carrier 304, the lens carrier / second OIS carrier 306, and the optical assembly 103 along the first axis for OIS movement of the optical assembly 103. For example, the first OIS coil 404 attached to the actuator assembly base 302 and/or the circuit 402 may be aligned with and may electromagnetically interact with the first OIS magnet 405 attached to first OIS carrier 304 to cause movement of the first OIS carrier 304, the lens carrier / second OIS carrier 306, and the optical assembly 103 along the first axis when the first OIS coil 404 receives an electrical current. Further, the first OIS carrier 304 may include second OIS ball bearings 408 that engage and move within second OIS tracks 410 formed on an object side of the first OIS carrier 304 and on an image side of the lens carrier / second OIS carrier 306. As such, the second OIS ball bearings 408 of the first OIS carrier 304 and the second OIS tracks 410 formed on the object side of the first OIS carrier 304 and on the image side of the lens carrier / second OIS carrier 306 may allow the lens carrier / second OIS carrier 306 and the optical assembly 103 to move independently of the first OIS carrier 304 and along the second axis (e.g., orthogonal to the optical axis 101 and the first axis) for OIS movement of the optical assembly 103. A VCM actuator including a second OIS coil 406 and a second OIS magnet 403 may move the lens carrier / second OIS carrier 306 and the optical assembly 103 along the second axis for OIS movement. For example, the second OIS coil 406 attached to the actuator assembly base 302 and/or the circuit 402 may be aligned with and may electromagnetically interact with the second OIS magnet 403 attached to the lens carrier / second OIS carrier 306 to cause movement of the lens carrier / second OIS carrier 306 and the optical assembly 103 along the second axis.

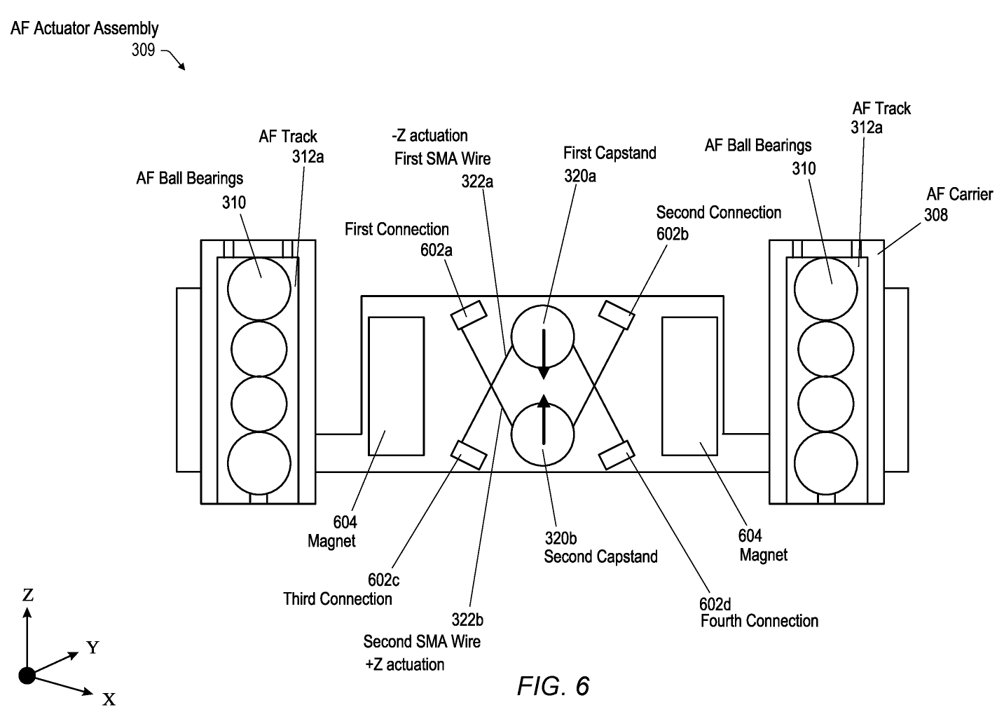

FIG. 6 illustrates components of an example AF actuator assembly 309 of an actuator module or assembly 200 that may, for example, be used to provide AF and OIS through lens movement in small form factor cameras, according to at least some embodiments. FIG. 6 shows a perspective view of an AF actuator assembly 309 of an actuator module or assembly 200. The AF actuator assembly 309 and the actuator assembly 200 may include one or more same or similar features as the features described with respect to or illustrated in FIGS. 1, 2, 3, 4, 5, 7, 8, 9, 10, 11, 12, 13, and 14. The example X-Y-Z coordinate system shown in FIG. 6 may be used to discuss aspects of components and/or systems, and may apply to embodiments described throughout this disclosure.

The AF carrier 308 (and the first OIS carrier 304 and the lens carrier / second OIS carrier 306) may move relative to the actuator assembly base 302. The AF carrier 308 (and the first OIS carrier 304, and the lens carrier / second OIS carrier 306 (and thus the optical assembly 103)) may move along the optical axis 101 relative to the actuator assembly base 302 when the AF actuator assembly 309 activates for AF. For example, the AF actuator assembly 309 may include AF ball bearings 310 residing within an AF track 312 vertically formed by both the AF carrier 308 and the actuator assembly base 302 allowing for AF movement along the optical axis 101 of the AF carrier 308 (and the first OIS carrier 304, the lens carrier / second OIS carrier 306, and the optical assembly 103) relative to the actuator base assembly 302. For example, the AF tracks 312a may be formed by the AF carrier 308 as shown in FIG. 6 and the AF tracks 312b may be formed by the actuator assembly base 302 as shown in FIG. 8. Pre-load plates attached to actuator assembly base 302 and magnets 604 attached to the AF carrier 308 and aligned with the pre-load plates draw the AF carrier 308 towards to the actuator assembly base 302 for retaining the AF ball bearings 310 within the AF tracks 312 formed by both the AF carrier 308 and the actuator assembly base 302. In some aspects, larger ball bearings may positioned at the ends of the AF tracks 312 with smaller ball bearings between the larger ball bearings. The configuration reduces friction during movement of the ball bearings within the AF tracks. Electrical connections 602 fixedly attached to the actuator assembly base 302 and/or a circuit 402 at least partially surrounding the plurality of carriers and that remains static with the actuator assembly base 302 and relative to movement of the AF carrier 308, retain ends of a pair of SMA wires 322 in a static position. For example, a first connection 602a and a second connection 602b fixedly attached to the circuit 402 are attached to ends of a first SMA wire 322a that loops over a first cap stand 320a. Similarly, a third connection 602c and a fourth connection 602d fixedly attached to the circuit 402 are attached to ends of a second SMA wire 322b that loops under a second cap stand 320b. The electrical connections 602 may carry an electrical current to and from the SMA wires 322 and mechanically attached (e.g., fixedly attach) or secure the SMA wires 322 to the static actuator assembly base 302 and/or the circuit 402. The AF carrier 308 includes a first cap stand 320a and a second cap stand 320b that extend from the AF carrier 308 in a direction orthogonal to the optical axis. The first cap stand 322a and the second cap stand 322b may be positioned in a vertical configuration with first cap stand 322a positioned above the second cap stand 322b in a direction along the optical axis 101. When the first SMA wire 322a looped around the first cap stand 320a receives an electrical current via the electrical connections 602a and 602b, the first SMA wire 322a contracts generating a force that pulls the AF carrier 308 (and the first OIS carrier 304, the lens carrier / second OIS carrier 306 and the optical assembly 103) along the optical axis 101 and towards the image sensor 108 and the actuator assembly base 302. When the second SMA wire 322b looped around the second cap stand 320b receives an electrical current via the electrical connections 602c and 602d, the second SMA wire 322b contracts generating a force that pulls the AF carrier 308, the first OIS carrier 304, the lens carrier / second OIS carrier 306 and the optical assembly 103 along the optical axis 101 and away from the image sensor 108. Thus, providing electrical current to the SMA wires 322 causes the SMA wires 322 to contract and move the optical assembly 103 along the optical axis 101 for AF movement.

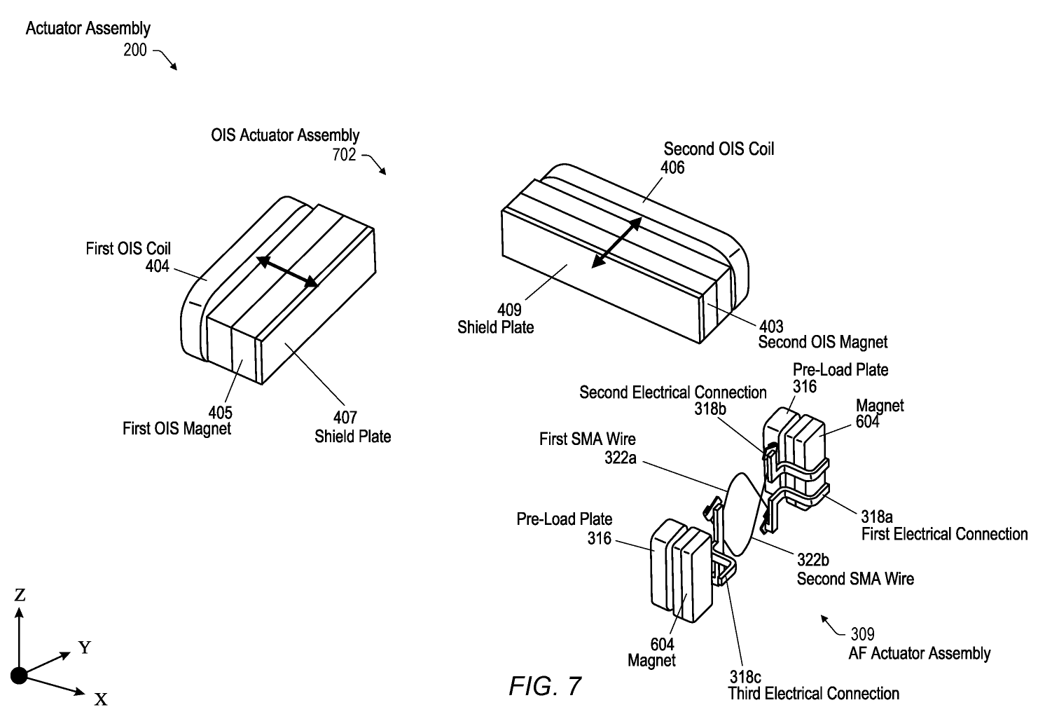

FIG. 7 illustrates components of an optical image stabilization (OIS) actuator assembly 702 and an AF actuator assembly 309 of an actuator module or assembly 200 that may, for example, be used to provide AF and OIS through lens movement in small form factor cameras, according to at least some embodiments. FIG. 7 shows a perspective view of an OIS actuator assembly 702 and an AF actuator assembly 309 of an actuator module or assembly 200. The OIS actuator assembly 702, the AF actuator assembly 309, and the actuator assembly 200 may include one or more same or similar features as the features described with respect to or illustrated in FIGS. 1, 2, 3, 4, 5, 6, 8, 9, 10, 11, 12, 13, and 14. The example X-Y-Z coordinate system shown in FIG. 7 may be used to discuss aspects of components and/or systems, and may apply to embodiments described throughout this disclosure.

As shown in FIG. 7, the actuator assembly 200 may include an OIS actuator assembly 702. The OIS actuator assembly 702 one or more VCM actuators. For example, OIS actuator assembly 702 may include a first OIS coil 404 attached to the circuit 402 and a first OIS magnet 405 attached to the first OIS carrier 304. The first OIS coil 404 may be aligned with the first OIS magnet 405 and may move the first OIS carrier 304, the lens carrier / second OIS carrier 306, and the optical assembly 103 along the first axis for OIS movement of the optical assembly 103. For example, the first OIS coil 404 attached to the actuator assembly base 302 and/or the circuit 402 may be aligned with and may electromagnetically interact with the first OIS magnet 405 attached to the first OIS carrier 304 to cause movement of the first OIS carrier 304, the lens carrier / second OIS carrier 306, and the optical assembly 103 along the first axis when the first OIS coil 404 receives an electrical current. The OIS actuator assembly 702 may also include a second OIS coil 406 attached to the circuit 402 and a second OIS magnet 403 attached to the lens carrier / second OIS carrier 306. The second OIS coil 406 may be aligned with the second OIS magnet 403 and may move the first OIS carrier 304, the lens carrier / second OIS carrier 306, and the optical assembly 103 along the second axis for OIS movement of the optical assembly 103. For example, the second OIS coil 406 attached to the actuator assembly base 302 and/or the circuit 402 may be aligned with and may electromagnetically interact with the second OIS magnet 403 attached to the lens carrier / second OIS carrier 306 to cause movement of the lens carrier / second OIS carrier 306, and the optical assembly 103 along the second axis when the second OIS coil 406 receives an electrical current. It should also be noted that pre-load plate may be positioned on a side of the first OIS coil 404 opposite the first OIS magnet 405 and on a side of the second OIS coil 406 opposite the second OIS magnet 403 for keeping the OIS magnets adjacent the OIS coils.

The actuator assembly 200 may also include the AF actuator assembly 309. The AF actuator assembly 309 may include magnets 604, pre-load plates 316, electrical connections 318, a first SMA wire 322a, and a second SMA wire 322b. In some aspects, the pre-load plates 316 may be replaced with magnets. The pre-load plates 316 may be attached to actuator assembly base 302 and the magnets 604 may be attached to the AF carrier 308 and aligned with the pre-load plates draw the AF carrier 308 towards to the actuator assembly base 302 for retaining the AF ball bearings within the AF tracks formed by both the AF carrier 308 and the actuator assembly base 302. The electrical connections 318 fixedly attached to the actuator assembly base 302 and/or a circuit 402 at least partially surrounding the plurality of carriers and that remains static with the actuator assembly base 302 and relative to movement of the AF carrier 308, retain ends of a pair of SMA wires 322 in a static position. For example, a first electrical connection 318a fixedly attached to the circuit 402 may also be attached to ends of a first SMA wire 322a that loops over a first cap stand 320. Similarly, a second electrical connection 318b fixedly attached to the circuit 402 may be attached to ends of a second SMA wire 322b that loops under a second cap stand 320. Further a third electrical connection 318c may carry the return current from the first SMA wire 318a and the second SMA wire 318b. The electrical connections 318a and 318b may carry an electrical current to and from the SMA wires 322 and mechanically attached (e.g., fixedly attach) or secure the SMA wires 322 to the static actuator assembly base 302 and/or the circuit 402. When the first SMA wire 322 looped around the first cap stand 320 receives an electrical current via the first electrical connection 318a, the first SMA wire 322 contracts generating a force that pulls the AF carrier 308 (and the first OIS carrier 304, the lens carrier / second OIS carrier 306 and the optical assembly 103) along the optical axis 101 and towards the image sensor 108 and the actuator assembly base 302. When the second SMA wire 322 looped around the second cap stand 320 receives an electrical current via the second electrical connection 318b, the second SMA wire 322 contracts generating a force that pulls the AF carrier 308, the first OIS carrier 304, the lens carrier / second OIS carrier 306 and the optical assembly 103 along the optical axis 101 and away from the image sensor 108. Thus, providing electrical current to the SMA wires 322 causes the SMA wires 322 to contract and move the optical assembly 103 along the optical axis 101 for AF movement.

FIG. 8 illustrates components of an example actuator module or assembly 200 that may, for example, be used to provide AF and OIS through lens movement in small form factor cameras, according to at least some embodiments. FIG. 8 shows a perspective view of the actuator module or assembly 200. The actuator assembly 200 may include one or more same or similar features as the features described with respect to or illustrated in FIGS. 1, 2, 3, 4, 5, 6, 7, 9, 10, 11, 12, 13, and 14. The example X-Y-Z coordinate system shown in FIG. 8 may be used to discuss aspects of components and/or systems, and may apply to embodiments described throughout this disclosure.

The actuator assembly 200 may include the actuator assembly base 302 and the AF actuator assembly 309. The actuator assembly base 302 may be static relative to AF carrier 308 (and the first OIS carrier 304 and the lens carrier / second OIS carrier 306) that moves along the optical axis 101 for AF. The AF actuator assembly 309 may include AF ball bearings 310 residing within an AF track 312 vertically formed by both the AF carrier 308 and the actuator assembly base 302 allowing for AF movement along the optical axis 101 of the AF carrier 308 (and the first OIS carrier 304, the lens carrier / second OIS carrier 306, and the optical assembly 103) relative to the actuator base assembly 302. For example, the AF tracks 312a may be formed by the AF carrier 308 as shown in FIG. 6 and the AF tracks 312b may be formed by the actuator assembly base 302 as shown in FIG. 8. Pre-load plates attached to the AF carrier 308 and magnets attached to the actuator assembly base 302 (or vis-versa) and aligned with the pre-load plates draw the AF carrier 308 towards to the actuator assembly base 302 for retaining the AF ball bearings 310 within the AF track 312 formed by both the AF carrier 308 and the actuator assembly base 302. Electrical connections 318 fixedly attached to the actuator assembly base 302 and/or a circuit 402 at least partially surrounding the plurality of carriers and that remains static with the actuator assembly base 302 and relative to movement of the AF carrier 308, retain ends of the SMA wires in a static position. For example, separate electrical connections 318 including a first electrical connection 318a and a second electrical connection 318b may provide electrical current to the first SMA wire 322a and the second SMA wire 322b, respectively, and a third electrical connection 318b may provide an electrical current return for both the first SMA wire 322a and the second SMA wire 322b. This allows each of the first SMA wire 322a and the second SMA wire 322b to be actuated independently. Accordingly, different amounts of electrical current may be provided (e.g., simultaneously) to the first SMA wire 322a and the second SMA wire 322b not only to move the optical assembly 103 along the optical axis 101, but also to control the speed at which the optical assembly 130 moves along the optical axis 101. The electrical connections 318 may also provide a fixed and static contact so that when the SMA wires 322 contract, the contraction causes movement of the AF carrier 308. In other words, the electrical connections 318 may carry an electrical current to and from the SMA wires 322 and mechanically attached (e.g., fixedly attach) or secure the SMA wires 322 to the static actuator assembly base 302 and/or the circuit 402. The SMA wires are looped around respective cap stands extending from the AF carrier 308 in a direction orthogonal to the optical axis and positioned in a vertical configuration with one cap stand above the other cap stand in a direction along the optical axis. When the first SMA wire 322a looped around the higher cap stand receives an electrical current via the electrical connections 318, the first SMA wire 322a contracts generating a force that pulls the AF carrier 308 (and the first OIS carrier 304, the lens carrier / second OIS carrier 306 and the optical assembly 103) along the optical axis 101 and towards the image sensor 108 and the actuator assembly base 302. When the second SMA wire 322b looped around the lower cap stand receives an electrical current via the electrical connections, the second SMA wire 322b contracts generating a force that pulls the AF carrier 308, the first OIS carrier 304, the lens carrier / second OIS carrier 306 and the optical assembly 103 along the optical axis 101 and away from the image sensor 108. Thus, providing electrical current to the SMA wires 322 causes the SMA wires to contract and move the optical assembly 103 along the optical axis 101 for AF movement.

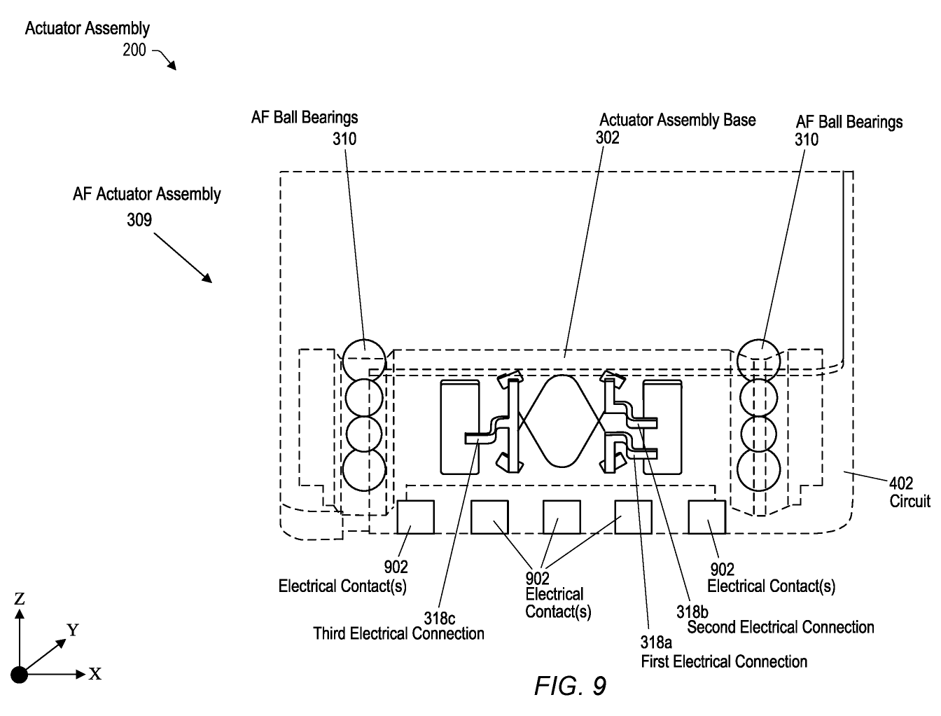

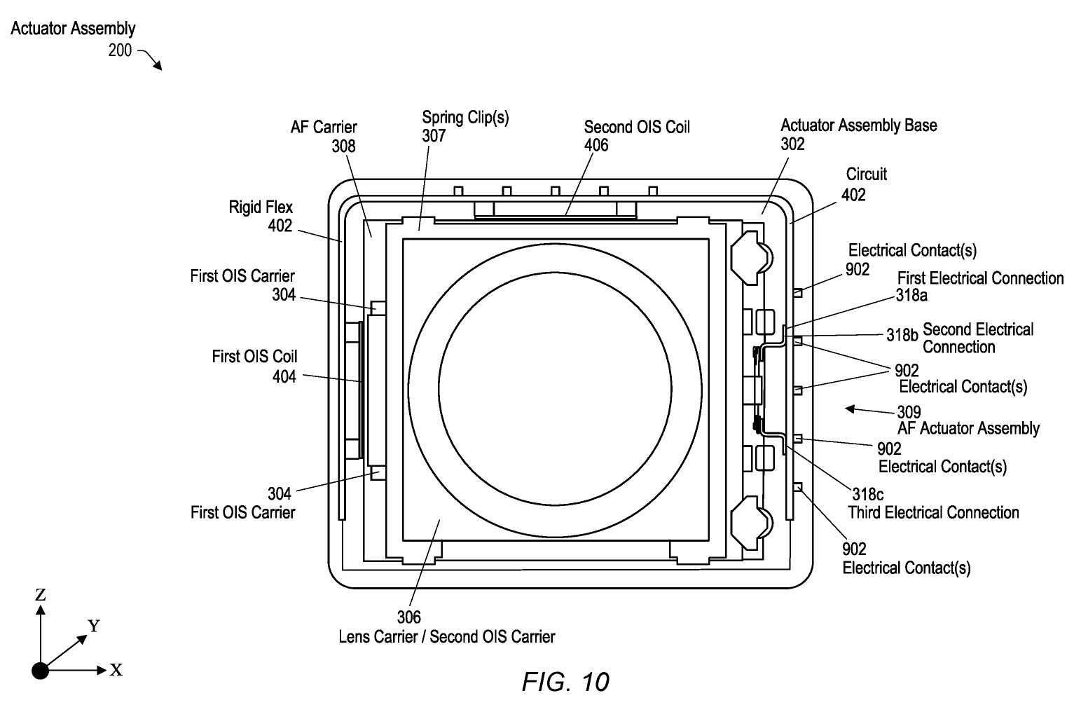

FIG. 9 illustrates components of an example actuator module or assembly 200 that may, for example, be used to provide AF and OIS through lens movement in small form factor cameras, according to at least some embodiments. FIG. 9 shows a perspective view of the actuator module or assembly 200. FIG. 10 illustrates components of an example actuator module or assembly 200 that may, for example, be used to provide AF and OIS through lens movement in small form factor cameras, according to at least some embodiments. FIG. 10 shows a perspective view of the actuator module or assembly 200.The actuator assembly 200 may include one or more same or similar features as the features described with respect to or illustrated in FIGS. 1, 2, 3, 4, 5, 6, 7, 8, 11, 12, 13, and 14. The example X-Y-Z coordinate system shown in FIGS. 9 and 10 may be used to discuss aspects of components and/or systems, and may apply to embodiments described throughout this disclosure.

As shown in FIGS. 9 and 10, that actuator assembly 200 may include the AF actuator assembly 309 and the circuit 402. The circuit 402 may wrap around the plurality of carriers and the actuator assembly base 302. The electrical connections 318 may extend from the SMA wires 322 through the actuator assembly base 302 and to the circuit 402 to provide and return electrical current through the SMA wires 322. Electrical contacts 902 may provide electrical current to and receive electrical current from the electrical connections 318 (e.g., the first electrical connection 318a, the second electrical connection 318b, the third electrical connection 318c) for the SMA wires 322 for AF movement of the optical assembly 103. In addition, the electrical contacts 902 may provide and return electrical current to the first OIS coil 404 and the second OIS coil 406 for OIS movement of the optical assembly 103.

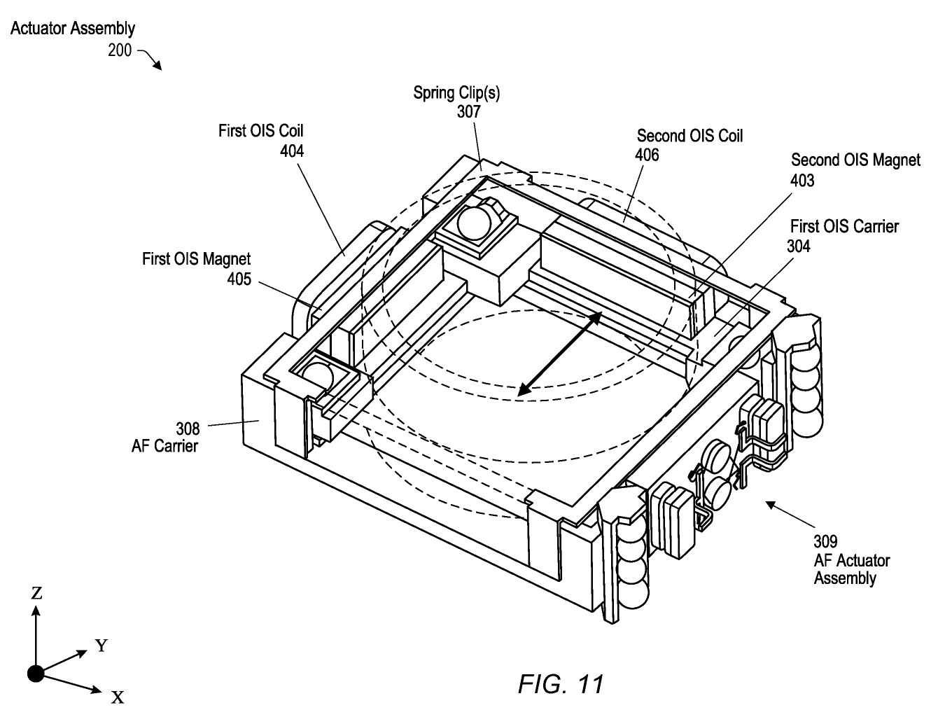

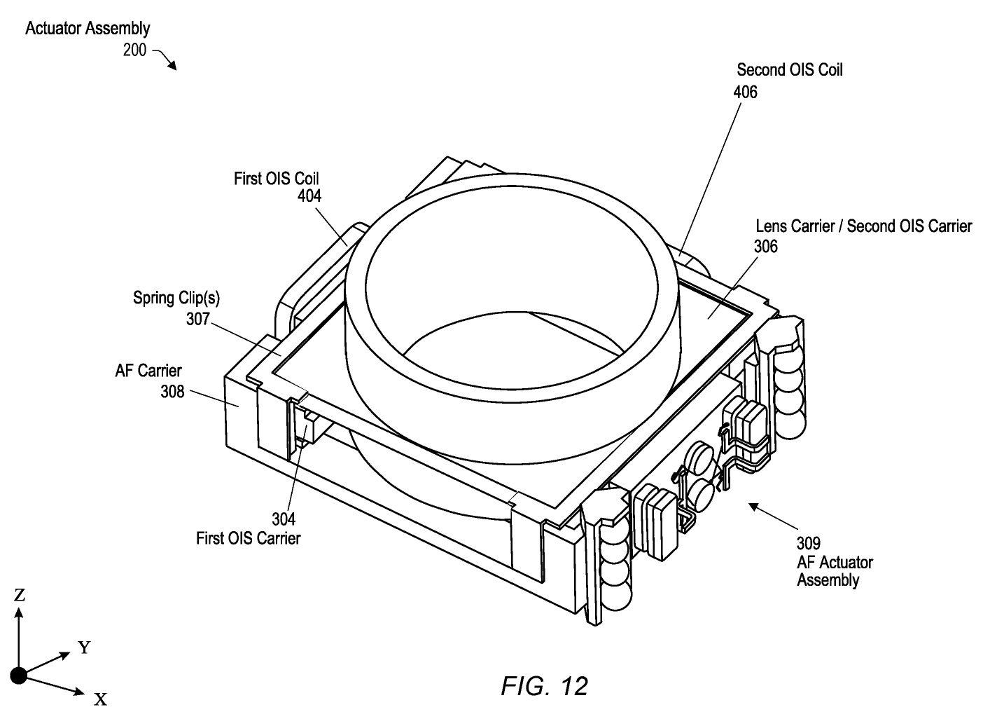

FIG. 11 illustrates components of an example actuator module or assembly 200 that may, for example, be used to provide AF and OIS through lens movement in small form factor cameras, according to at least some embodiments. FIG. 11 shows a perspective view of the actuator module or assembly 200. FIG. 12 illustrates components of an example actuator module or assembly 200 that may, for example, be used to provide AF and OIS through lens movement in small form factor cameras, according to at least some embodiments. FIG. 12 shows a perspective view of the actuator module or assembly 200. The actuator assembly 200 may include one or more same or similar features as the features described with respect to or illustrated in FIGS. 1, 2, 3, 4, 5, 6, 7, 8, 9, 10, 13, and 14. The example X-Y-Z coordinate system shown in FIG. 12 may be used to discuss aspects of components and/or systems, and may apply to embodiments described throughout this disclosure.

As shown in FIGS. 11 and 12, the actuator assembly 200 of the camera 100 may include the AF carrier 308, the first OIS carrier 304, and the lens carrier / second OIS carrier 306. The AF carrier 308 may be positioned on the actuator assembly base 302. As such, when the image sensor 108 is positioned below the actuator assembly base 302 on an opposite side of the actuator assembly base 302 from the optical assembly 103, the vertical stack of carriers may be arranged from the image sensor 108 to the optical assembly 103 in an order as follows: the actuator assembly base 302, the AF carrier 308, first OIS carrier 304, and the lens carrier / second OIS carrier 306. Unlike some actuator assemblies that utilize a plurality of VCM actuators for both OIS movement and AF movement, the actuator assembly 200 may including an AF actuator assembly 309 that utilizes SMA wires 332 for AF movement of the optical assembly 103 via the AF carrier 308 while the actuator assembly 200 utilizes VCM actuators for OIS movement of the optical assembly 130. Using SMA wires for AF movement of the optical assembly 103 may provide higher actuation forces to overcome and attenuate high frequency and high acceleration disturbances.

The AF carrier 308, the first OIS carrier 304, and the lens carrier / second OIS carrier 306 may move relative to the actuator assembly base 302. The AF carrier 308, the first OIS carrier 304, and the lens carrier / second OIS carrier 306 (and thus the optical assembly 103) may move along the optical axis 101 relative to the actuator assembly base 302 when the AF actuator assembly 309 activates for AF. For example, the AF actuator assembly 309 may include AF ball bearings 310 residing within an AF track 312 vertically formed by both the AF carrier 308 and the actuator assembly base 302 allowing for AF movement along the optical axis 101 of the AF carrier 308, the first OIS carrier 304, the lens carrier / second OIS carrier 306, and the optical assembly 103 relative to the actuator base assembly 302. Pre-load plates attached to the AF carrier 308 and magnets attached to the actuator assembly base 302 and aligned with the pre-load plates 316 draw the AF carrier 308 towards to the actuator assembly base 302 for retaining the ball bearings within the AF track formed by both the AF carrier 308 and the actuator assembly base 302. Electrical connections fixedly attached to the actuator assembly base 302 and/or the circuit 402 at least partially surrounding the plurality of carriers and that remains static with the actuator assembly base 302 and relative to movement of the AF carrier 308, retain ends of a pair of SMA wires 322 in a static position. The electrical connections may carry an electrical current to and from the SMA wires 322 and mechanically attached (e.g., fixedly attach) or secure the SMA wires 322 to the static actuator assembly base 302 and/or the circuit 402. The SMA wires 322 are looped around respective cap stands extending from the AF carrier 308 in a direction orthogonal to the optical axis 101 and positioned in a vertical configuration with one cap stand above the other cap stand in a direction along the optical axis 101. When an SMA wire 322 looped around the higher cap stand receives an electrical current via the electrical connections, that SMA wire 322 contracts generating a force that pulls the AF carrier 308, the first OIS carrier 304, the lens carrier / second OIS carrier 306 and the optical assembly 103 along the optical axis 101 and towards the image sensor 108. When an SMA wire 322 looped around the lower cap stand receives an electrical current via the electrical connections, that SMA wire 322 contracts generating a force that pulls the AF carrier 308, the first OIS carrier 304, the lens carrier / second OIS carrier 306 and the optical assembly 103 along the optical axis 101 and away from the image sensor 108. Thus, providing electrical current to the SMA wires 322 causes the SMA wires to contract and move the optical assembly 103 along the optical axis 101 for AF movement.

The AF carrier 308 may also include first OIS ball bearings 412 that engage and move within first OIS tracks 414 formed on an object side of the AF carrier 308 and an image side of the first OIS carrier 304. As such, the first OIS ball bearings 412 and the first OIS tracks 414 formed on the object side of the AF carrier 308 and the image side of the first OIS carrier 304 may allow the first OIS carrier 304, the lens carrier / second OIS carrier 306, and optical assembly 103 to move along first axis (e.g., orthogonal to the optical axis 101) for OIS movement of the optical assembly 103. A VCM actuator including a first OIS coil 404 attached to the circuit 402 and a first OIS magnet 405 attached to the first OIS carrier 304 may move the first OIS carrier 304, the lens carrier / second OIS carrier 306, and the optical assembly 103 along the first axis for OIS movement of the optical assembly 103. For example, the first OIS coil 404 attached to the actuator assembly base 302 and/or the circuit 402 may be aligned with and may electromagnetically interact with the first OIS magnet 405 attached to the first OIS carrier 304 to cause movement of the first OIS carrier 304, the lens carrier / second OIS carrier 306, and the optical assembly 103 along the first axis when the first OIS coil 404 receives an electrical current. Further, the first OIS carrier 304 may include second OIS ball bearings 408 that engage and move within second OIS tracks 410 formed on an object side of the first OIS carrier 304 and on an image side of the lens carrier / second OIS carrier 306. As such, the second OIS ball bearings 408 of the first OIS carrier 304 and the second OIS tracks 410 formed on the object side of the first OIS carrier 304 and on the image side of the lens carrier / second OIS carrier 306 may allow the lens carrier / second OIS carrier 306 and the optical assembly 103 to move independently of the first OIS carrier 304 and along the second axis (e.g., orthogonal to the optical axis 101 and the first axis) for OIS movement of the optical assembly 103. A VCM actuator including a second OIS coil 406 and a second OIS magnet 403 may move the lens carrier / second OIS carrier 306 and the optical assembly 103 along the second axis for OIS movement. For example, the second OIS coil 406 attached to the actuator assembly base 302 and/or the circuit 402 may be aligned with and may electromagnetically interact with the second OIS magnet 403 attached to the lens carrier / second OIS carrier 306 to cause movement of the lens carrier / second OIS carrier 306 and the optical assembly 103 along the second axis.

FIG. 13 illustrates a schematic representation of an example device 1300 that may include a camera (e.g., as described herein with respect to FIGS. 1, 2, 3, 4, 5, 6, 7, 8, 9, 10, 13, 12, and 14), in accordance with some embodiments. In some embodiments, the device 1300 may be a mobile device and/or a multifunction device. In various embodiments, the device 1300 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 1300 may include a display system 1302 (e.g., comprising a display and/or a touch-sensitive surface) and/or one or more cameras 1304. In some non-limiting embodiments, the display system 1302 and/or one or more front-facing cameras 1304a may be provided at a front side of the device 1300, e.g., as indicated in FIG. 13. Additionally, or alternatively, one or more rear-facing cameras 1304b may be provided at a rear side of the device 1300. In some embodiments comprising multiple cameras 1304, some or all of the cameras may be the same as, or similar to, each other. Additionally, or alternatively, some or all of the cameras may be different from each other. In various embodiments, the location(s) and/or arrangement(s) of the camera(s) 1304 may be different than those indicated in FIG. 13.

Among other things, the device 1300 may include memory 1306 (e.g., comprising an operating system 1308 and/or application(s)/program instructions 1310), one or more processors and/or controllers 1312 (e.g., comprising CPU(s), memory controller(s), display controller(s), and/or camera controller(s), etc.), and/or one or more sensors 1316 (e.g., orientation sensor(s), proximity sensor(s), and/or position sensor(s), etc.). In some embodiments, the device 1300 may communicate with one or more other devices and/or services, such as computing device(s) 1318, cloud service(s) 1320, etc., via one or more networks 1322. For example, the device 1300 may include a network interface (e.g., network interface 1310) that enables the device 1300 to transmit data to, and receive data from, the network(s) 1322. Additionally, or alternatively, the device 1300 may be capable of communicating with other devices via wireless communication using any of a variety of communications standards, protocols, and/or technologies.

FIG. 14 illustrates a schematic block diagram of an example computing device, referred to as computer system 1400, that may include or host embodiments of a camera (e.g., as described herein with respect to FIGS. 1, 2, 3, 4, 5, 6, 7, 8, 9, 10, 11, 12, and 13). In addition, computer system 1400 may implement methods for controlling operations of the camera and/or for performing image processing images captured with the camera. In some embodiments, the device 1400 (described herein with reference to FIG. 14) may additionally, or alternatively, include some or all of the functional components of the computer system 1400 described herein.

The computer system 1400 may be configured to execute any or all of the embodiments described above. In different embodiments, computer system 1400 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 1400 includes one or more processors 1402 coupled to a system memory 1404 via an input/output (I/O) interface 1406. Computer system 1400 further includes one or more cameras 1408 coupled to the I/O interface 1406. Computer system 1400 further includes a network interface 1410 coupled to I/O interface 1406, and one or more input/output devices 1412, such as cursor control device 1414, keyboard 1416, and display(s) 1418. In some cases, it is contemplated that embodiments may be implemented using a single instance of computer system 1400, while in other embodiments multiple such systems, or multiple nodes making up computer system 1400, may be configured to host different portions or instances of embodiments. For example, in one embodiment some elements may be implemented via one or more nodes of computer system 1400 that are distinct from those nodes implementing other elements.

In various embodiments, computer system 1400 may be a uniprocessor system including one processor 1402, or a multiprocessor system including several processors 1402 (e.g., two, four, eight, or another suitable number). Processors 1402 may be any suitable processor capable of executing instructions. For example, in various embodiments processors 1402 may be general-purpose or embedded processors implementing any of a variety of instruction set architectures (ISAs), such as the x86, PowerPC, SPARC, or MIPS ISAs, or any other suitable ISA. In multiprocessor systems, each of processors 1402 may commonly, but not necessarily, implement the same ISA.

System memory 1404 may be configured to store program instructions 1420 accessible by processor 1402. In various embodiments, system memory 1404 may be implemented using any suitable memory technology, such as static random access memory (SRAM), synchronous dynamic RAM (SDRAM), nonvolatile/Flash-type memory, or any other type of memory. Additionally, existing camera control data 1422 of memory 1404 may include any of the information or data structures described above. In some embodiments, program instructions 1420 and/or data 1422 may be received, sent or stored upon different types of computer-accessible media or on similar media separate from system memory 1404 or computer system 1400. In various embodiments, some or all of the functionality described herein may be implemented via such a computer system 1400.

In one embodiment, I/O interface 1406 may be configured to coordinate I/O traffic between processor 1402, system memory 1404, and any peripheral devices in the device, including network interface 1410 or other peripheral interfaces, such as input/output devices 1412. In some embodiments, I/O interface 1406 may perform any necessary protocol, timing or other data transformations to convert data signals from one component (e.g., system memory 1404) into a format suitable for use by another component (e.g., processor 1402). In some embodiments, I/O interface 1406 may include support for devices attached through various types of peripheral buses, such as a variant of the Peripheral Component Interconnect (PCI) bus standard or the Universal Serial Bus (USB) standard, for example. In some embodiments, the function of I/O interface 1406 may be split into two or more separate components, such as a north bridge and a south bridge, for example. Also, in some embodiments some or all of the functionality of I/O interface 1406, such as an interface to system memory 1404, may be incorporated directly into processor 1402.

Network interface 1410 may be configured to allow data to be exchanged between computer system 1400 and other devices attached to a network 1424 (e.g., carrier or agent devices) or between nodes of computer system 1400. Network 1424 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1410 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1412 may, in some embodiments, include one or more display terminals, keyboards, keypads, touchpads, scanning devices, voice or optical recognition devices, or any other devices suitable for entering or accessing data by one or more computer systems 1400. Multiple input/output devices 1412 may be present in computer system 1400 or may be distributed on various nodes of computer system 1400. In some embodiments, similar input/output devices may be separate from computer system 1400 and may interact with one or more nodes of computer system 1400 through a wired or wireless connection, such as over network interface 1410.

Those skilled in the art will appreciate that computer system 1400 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1400 may be transmitted to computer system 1400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A camera, comprising:
an optical assembly having one or more lenses defining an optical axis;
an actuator assembly, wherein the actuator assembly comprises:
a plurality of carriers, wherein respective carriers of the plurality of carriers are configured to allow movement of the optical assembly along respective axes of the optical axis, a first axis orthogonal to the optical axis, and a second axis orthogonal to the first axis and the optical axis;
a plurality of ball bearings for the respective carriers, wherein respective ball bearings of the plurality of ball bearings are for allowing movement along the respective axes; and
a plurality of actuators, wherein respective actuators of the plurality of actuators are configured to move the optical assembly, via the respective carriers, along the respective axes, wherein the plurality of actuators comprises one or more shape memory alloy (SMA) wires for moving the optical assembly, via at least one carrier of the plurality of carriers, along the optical axis for autofocus (AF).

2. The camera of claim 1, wherein the plurality of carriers comprises at least a first optical image stabilization (OIS) carrier, a second OIS carrier, and an AF carrier that are arranged in a stacked configuration along the optical axis.

3. The camera of claim 2, wherein the second OIS carrier is fixedly attached to the optical assembly, and wherein the first OIS carrier is positioned between the AF carrier and the second OIS carrier along the optical axis.

4. The camera of claim 1, wherein the actuator assembly further comprises a circuit wrapping at least partially around the plurality of carriers and comprising one or more OIS coils for OIS movement of the optical assembly, wherein the circuit is configured to provide electrical current to the one or more OIS coils for OIS movement of the optical assembly and to the SMA wires for AF movement of the optical assembly.

5. The camera of claim 4, wherein the actuator assembly further comprises one or more OIS magnets, wherein the one or more OIS magnets are aligned with the one or more OIS coils for generating Lorentz forces for OIS movement of the optical assembly.

6. The camera of claim 5, wherein the one or more OIS magnets comprise:
a first OIS magnet attached to a first OIS carrier of the plurality of carriers for movement of the optical assembly along the first axis; and
a second OIS magnet attached to a second OIS carrier of the plurality of carriers for movement of the optical assembly along the second axis.

7. The camera of claim 1, wherein the actuator assembly further comprises an actuator assembly base, wherein an AF carrier of the plurality of carriers and the actuator assembly base form one or more vertical tracks for one or more sets of AF ball bearings of the plurality of ball bearings for allowing AF movement of the AF carrier and the optical assembly along the optical axis.

8. A device, comprising:
one or more processors;
memory storing program instructions executable by the one or more processors to control operation of a camera; and
the camera comprising:
an optical assembly having one or more lenses defining an optical axis;
an actuator assembly, wherein the actuator assembly comprises:
a plurality of carriers, wherein respective carriers of the plurality of carriers are configured to allow movement of the optical assembly along respective axes of the optical axis, a first axis orthogonal to the optical axis, and a second axis orthogonal to the first axis and the optical axis;
a plurality of ball bearings for the respective carriers, wherein respective ball bearings of the plurality of ball bearings are for allowing movement along the respective axes; and
a plurality of actuators, wherein respective actuators of the plurality of actuators are configured to move the optical assembly, via the respective carriers, along the respective axes, wherein the plurality of actuators comprises one or more shape memory alloy (SMA) wires for moving the optical assembly, via at least one carrier of the plurality of carriers, along the optical axis for autofocus (AF).

9. The device of claim 8, wherein the plurality of carriers comprises at least a first optical image stabilization (OIS) carrier, a second OIS carrier, and an AF carrier that are arranged in a stacked configuration along the optical axis.

10. The device of claim 9, wherein the second OIS carrier is fixedly attached to the optical assembly, and wherein the first OIS carrier is positioned between the AF carrier and the second OIS carrier along the optical axis.

11. The device of claim 8, wherein the actuator assembly further comprises a circuit wrapping at least partially around the plurality of carriers and comprising one or more OIS coils for OIS movement of the optical assembly, wherein the circuit is configured to provide electrical current to the one or more OIS coils for OIS movement of the optical assembly and to the SMA wires for AF movement of the optical assembly.

12. The device of claim 11, wherein the actuator assembly further comprises one or more OIS magnets fixedly attached to the second OIS carrier, wherein the one or more OIS magnets are aligned with the one or more OIS coils for generating Lorentz forces for OIS movement of the optical assembly.

13. The device of claim 12, wherein the one or more OIS magnets comprise:
a first OIS magnet attached to a first OIS carrier of the plurality of carriers for movement of the optical assembly along the first axis; and
a second OIS magnet attached to a second OIS carrier of the plurality of carriers for movement of the optical assembly along the second axis.

14. The device of claim 8, wherein the actuator assembly further comprises an actuator assembly base, wherein an AF carrier of the plurality of carriers and the actuator assembly base form one or more vertical tracks for one or more sets of AF ball bearings of the plurality of ball bearings for allowing AF movement of the AF carrier and the optical assembly along the optical axis.

15. An actuator assembly, comprising:
a plurality of carriers, wherein respective carriers of the plurality of carriers are configured to allow movement of an optical assembly of a camera along respective axes of an optical axis, a first axis orthogonal to the optical axis, and a second axis orthogonal to the first axis and the optical axis;
a plurality of ball bearings for the respective carriers, wherein respective ball bearings of the plurality of ball bearings are for allowing movement along the respective axes; and
a plurality of actuators, wherein respective actuators of the plurality of actuators are configured to move the optical assembly, via the respective carriers, along the respective axes, wherein the plurality of actuators comprises one or more shape memory alloy (SMA) wires for moving the optical assembly, via at least one carrier of the plurality of carriers, along the optical axis for autofocus (AF).

16. The actuator assembly of claim 15, wherein the plurality of carriers comprises at least a first optical image stabilization (OIS) carrier, a second OIS carrier, and an AF carrier that are arranged in a stacked configuration along the optical axis.

17. The actuator assembly of claim 16, wherein the second OIS carrier is fixedly attached to the optical assembly, and wherein the first OIS carrier is positioned between the AF carrier and the second OIS carrier along the optical axis.

18. The actuator assembly of claim 15, wherein the actuator assembly further comprises a circuit wrapping at least partially around the plurality of carriers and comprising one or more OIS coils for OIS movement of the optical assembly, wherein the circuit is configured to provide electrical current to the one or more OIS coils for OIS movement of the optical assembly and to the SMA wires for AF movement of the optical assembly.

19. The actuator assembly of claim 18, wherein the actuator assembly further comprises one or more OIS magnets fixedly attached to the second OIS carrier, wherein the one or more OIS magnets are aligned with the one or more OIS coils for generating Lorentz forces for OIS movement of the optical assembly.

20. The actuator assembly of claim 15, wherein the actuator assembly further comprises an actuator assembly base, wherein an AF carrier of the plurality of carriers and the actuator assembly base form one or more vertical tracks for one or more sets of AF ball bearings of the plurality of ball bearings for allowing AF movement of the AF carrier and the optical assembly along the optical axis.
